(19) United States
(12) Patent Application Publication
(10) Pub. No.: US 2026/0300961 A1
(43) Pub. Date: Oct. 1, 2026

(54) ELECTRONIC WALLET AND ACCOMODATION OF TRANSACTION LIMITS WITH A CENTRAL BANK DIGITAL CURRENCY

(71) Applicant: American Express Travel Related Services Company, Inc., New York, NY (US)

(72) Inventors: Lucky Bimolaksono, Sydney (AU); Dean Nicolson, Sydney (AU)

(21) Appl. No.: 19/698,653

(22) Filed: Jun. 4, 2026

Related U.S. Application Data
(63) Continuation of application No. 18/174,204, filed on Feb. 24, 2023.

(51) Int. Cl. G06Q 20/36; G06Q 20/02; G06Q 20/10; G06Q 20/22; G06Q 20/38

(52) U.S. Cl. CPC G06Q 20/3678; G06Q 20/108; G06Q 20/227; G06Q 20/381; G06Q 20/3829; G06Q 20/02

(57) ABSTRACT

Disclosed are various embodiments for conducting central bank digital currency (CBDC) transactions. A user CBDC wallet can be stored in a wallet application corresponding to a wholesale wallet, which can allow users to conduct transactions that might otherwise be impractical using the user wallet. Multiple funding sources can be accommodated by the wallet application.

### CROSS-REFERENCE TO RELATED APPLICATIONS

This application is a continuation of, claims priority to, and the benefit of, co-pending U.S. application Ser. No. 18/174,204, entitled “ELECTRONIC WALLET AND ACCOMMODATION OF TRANSACTION LIMITS WITH A CENTRAL BANK DIGITAL CURRENCY” and filed on Feb. 24, 2023, the entire contents of which are incorporated herein by reference as if set forth in its entirety.

### BACKGROUND

Central bank digital currencies (CBDCs) can be issued by central banks or governments to allow for an electronic currency that is authorized by the issuing governments. These CBDCs can be fiat currencies that are backed by a commodity or liability on the issuing central bank and differ from cryptocurrencies in that they may be accompanied by governmental rules and regulations concerning their issuance and use by the public. The implementation of a CBDC can be similar or in some cases identical to cryptocurrencies that are not issued by a government or central bank. However, cryptocurrencies that are not issued by a government or central bank often have limited or no regulatory restrictions in place that accompany the use or issuance of the currency.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting an example transaction scenario according to various embodiments of the present disclosure.

FIG. 2 is a drawing of a network environment according to various embodiments of the present disclosure.

FIG. 3 is a drawing of an example user interface rendered by a client device in the network environment of FIG. 2 according to various embodiments of the present disclosure.

FIG. 4 is a drawing of an example user interface rendered by a client device in the network environment of FIG. 2 according to various embodiments of the present disclosure.

FIG. 5 is a flowchart illustrating one example of functionality implemented as portions of an application executed in a computing environment in the network environment of FIG. 2 according to various embodiments of the present disclosure.

FIG. 6 is a flowchart illustrating one example of functionality implemented as portions of an application executed on a client device in the network environment of FIG. 2 according to various embodiments of the present disclosure.

FIG. 7 is a flowchart illustrating one example of functionality implemented as portions of an application executed on a client device in the network environment of FIG. 2 according to various embodiments of the present disclosure.

FIG. 8 is a flowchart illustrating one example of functionality implemented as portions of an application executed on a client device in the network environment of FIG. 2 according to various embodiments of the present disclosure.

### DETAILED DESCRIPTION

The embodiments of the present disclosure relate to an electronic wallet system that can accommodate central bank digital currency (CBDC) for transactions conducted with merchant systems. Embodiments of the disclosure are further directed to a system that accommodates regulatory limits or other restrictions that are imposed on CBDCs by an authority issuing the CBDC to the public or a party involved in the transactions or usage of the CBDC.

Cryptocurrency has continued to grow in acceptance among the public and regulatory authorities. As the use of cryptocurrencies increases, governments and central banks are increasingly adopting or piloting CBDCs. CBDCs can utilize similar technology as cryptocurrencies, but are also fiat or reserve backed currencies that are issued or endorsed by governments or their respective central banks. In some cases, these CBDCs can be accompanied by restrictions, regulations, and limitations that can limit the usability of the CBDC. Issuing authorities might require that the public obtain and utilize CBDCs by working through chartered or regulated banks or licensed Financial Services provider so that anti money-laundering, tax, and other rules and regulations can be followed.

In some jurisdictions and technological environments, a CBDC wallet that is assigned to an individual can have transaction limits that in turn limit the usability of the wallet. For example, a regulatory scheme might impose a limit on the total amount of funds that can be held in an individual or personal CBDC wallet, which can limit its use in large transactions.

Various embodiments of the present disclosure relate to providing usability for CBDC wallets for larger transactions through a wholesale CBDC wallet that can be issued to or on behalf of a bank or licensed Financial Services provider that is authorized to conduct larger transactions using a particular CBDC infrastructure. Additionally, examples of the disclosure relate to providing a wallet application on a client device through which a user can utilize personal CBDC wallets, bank-issued CBDC wallets, cryptocurrency, rewards points, credit cards, and other payment instruments for which a payment token or tokens can be stored on a client device and utilized to make payments.

In the context of this disclosure, a CBDC can refer to a digital currency issued by a central bank of a government. In some scenarios, a CBDC can be implemented using a database managed by a central bank of a government organization. The database may constitute a blockchain or distributed ledger. Thus, instead of accepting and holding cryptocurrency, the embodiments allow for users and merchants to transact using the CBDC. This aspect provides various advantages for merchants because CBDC is a more stable form of currency since it is backed by a government entity.

Additionally, in some examples, the embodiments can facilitate payment between a user and a merchant by conducting an exchange whereby a funding source can be utilized to obtain a transaction amount of a CBDC or a merchant's preferred currency. The transaction amount of the currency can be provided to the merchant by a wallet application on the client device.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

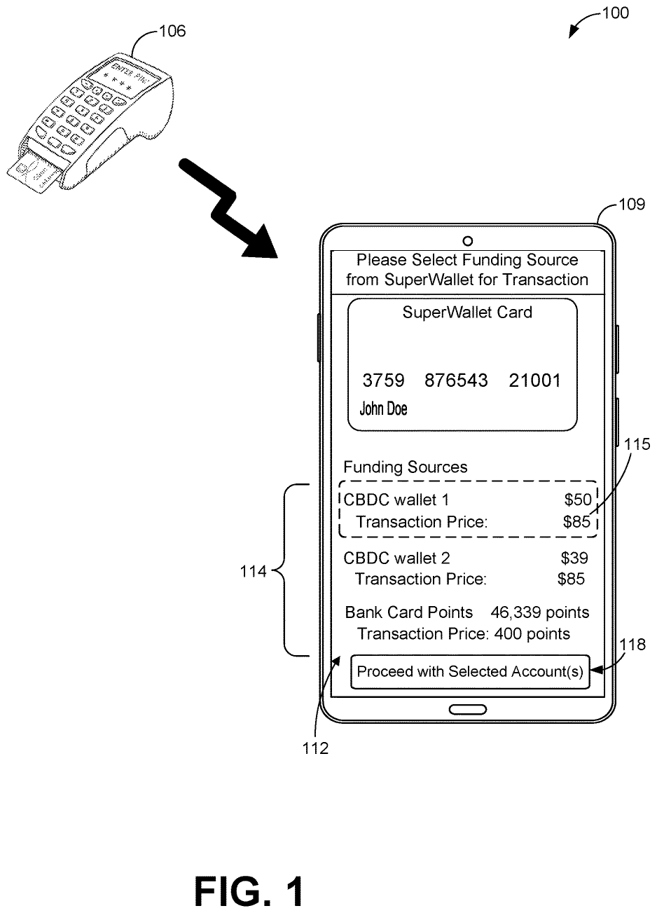

As illustrated in FIG. 1, shown is a drawing depicting an example transaction scenario 100 of a user using a payment instrument for a transaction at a point of sale (POS) device 106. In this example scenario, a user has approached the POS device 106. The POS device 106 can display a transaction amount for a transaction. The user can select to make a payment at the POS device 106. The POS device 106 can indicate that it is ready to accept a payment card. The user can tap a client device 109 to initiate communication with the POS device 106. The client device 109 and POS device 106 can communicate via near-field communication (NFC), for example, or other short-range wireless protocols.

The POS device 106 can receive a payment token from the client device 109 and include the payment token in an authorization request. The POS device 106 can transmit the authorization request to a remote computing device of an issuer (e.g., financial service provider). The remote computing device can identify the payment token having a configuration setting for requesting a selection of a funding source from a client device 109 for the transaction. The remote computing device can transmit an activation instruction to a mobile application associated with the issuer installed on the client device 109. The activation instruction can cause the client device 109 to display a user interface 112 for selecting a funding source (e.g., a financial account) for the transaction. In the illustrated embodiment, the user interface 112 can display multiple funding sources 114 to the user in the user interface 112. The user interface 112 can be rendered by a wallet application running on the client device 109 which is authorized to conduct payment transactions on behalf of the user.

The funding sources 114 can be loaded into the wallet application by a user by associating the various funding sources with the wallet application. For example, the user could authorize the wallet application to hold one or more keys for a user's CBDC wallet. In some cases, the user can have multiple CBDC wallets so that the user can utilize the wallet application to spend or manage these multiple CBDC wallets. In some cases, the wallet application can utilize cryptocurrency accounts as a funding source 114. Additionally, the wallet application can utilize other types of non-currency funding sources 114, such as rewards points, airline miles, or other sources of value or non-currency amounts.

The wallet application can be an application that communicates with a hosted custodial wallet that controls the private keys so that that the user can interact with the hosted wallet using the wallet application. In another example, the wallet application can comprise a non-custodial wallet application where the user retains the private keys or password required to utilize the funds associated with the wallet. To conduct a transaction with the wallet application, the user can initiate a transaction with the POS device 106 and then select a funding source 114 within the user interface 112. In some cases, the transaction amount might exceed the funds available within a particular funding source 114, so the user can select multiple funding sources 114. In some implementations, the wallet application can select the funding sources 114 to equal the transaction amount automatically.

For example, in some jurisdictions, there might be a limit to the amount of funds that can be held in a CBDC wallet due to regulatory limitations. Accordingly, the wallet application can select from among multiple CBDC wallets associated with the user to obtain currency equaling the transaction amount. In the example shown in FIG. 1, the wallet application can select from the CBDC wallet 1 and the CBDC wallet 2 to obtain funds equaling the transaction amount.

In other scenarios, the wallet application can allow the user to select one or more funding sources 114 and select the proceed button 118. After the user clicks on the proceed button 118, the remote computing device can proceed with an approval stage in authorizing the transaction at the POS device 106 with the selection 115 of the cryptocurrency account. After the accounts have been approved for the transaction, the remote computing device can debit the transaction amount from the one or more funding sources 114 selected for the transaction. In this example, the settlement process can involve crediting the transaction price (e.g., in a digital currency) in a CBDC blockchain preferred by the merchant of the POS device 106 and debiting the transaction price in the CBDC blockchain associated with the CBDC wallet 1 and CBDC wallet 2.

The embodiments of the present disclosure deviate from traditional payment processing because the embodiments can provide a real-time or near real-time ability to settle merchant transactions. In contrast, traditional payment processing often involves financial service providers handling transactions in batches. As a result, the settlement process for traditional payment processing can take multiple days before the merchant receives their proceeds because the payment must be processed as part of a batch payments rather than when the payment is submitted. Additionally, because of the improved speed for processing and settling merchant transactions, the embodiments can enable merchant systems to safely accept cryptocurrencies as a form of payment at a POS device with their existing POS devices 106 by reducing the merchant's exposure to volatile changes in the price of the underlying cryptocurrency.

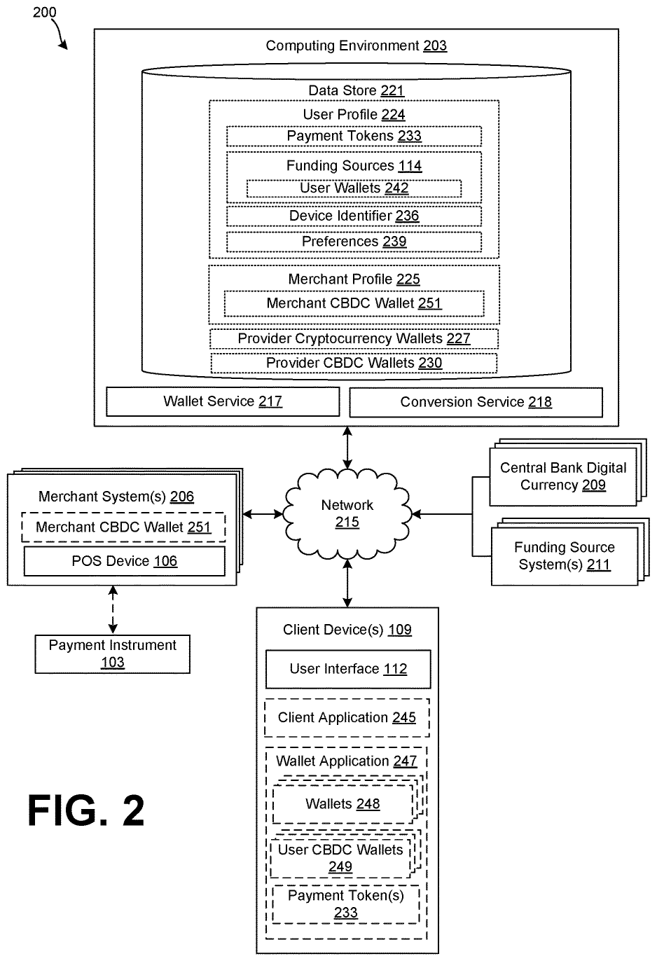

With reference to FIG. 2, shown is a network environment 200 according to various embodiments. The network environment 200 can include a computing environment 203, a merchant system 206, a Central Bank Digital Currency (CBDC) network 209, a funding source system 211, and the client device 109, which can be in data communication with each other via a network 215.

The network 215 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 215 can also include a combination of two or more networks 215. Examples of networks 215 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content. In some embodiments, the computing environment 203 can represent a remote computing device of a financial services provider, such as a retail bank, an issuing bank, an acquiring bank, or other suitable financial service providers.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a wallet service 217, a conversion service 218, and other applications, services, processes, systems, engines, or functionality not discussed in detail herein.

The wallet service 217 can communicate with a wallet application 247 running on a client device 109 to facilitate the addition of funding sources or other wallets 248 to the wallet application 247. The wallet service 217 can communicate with a payment issuer in the case of a payment requiring authorization by a third party, such as a card issuer, to add a payment instrument to a wallet application 247 or to authorize payments made by a payment instrument. In some implementations, the functionality of the wallet service 217 can be implemented by the wallet application 247 on the client device 109.

The conversion service 218 can facilitate the acceptance of payments at merchant POS systems or devices or through other payment rails. The conversion service 218 can convert currencies such as cryptocurrencies, rewards points, airline miles, foreign currency, and other types of payments to a central bank digital currency to facilitate transactions between users and merchants. Additionally, the conversion service 218 can receive authorization from the client device 109 to process a transaction at a POS device 106 from one or more funding source 114.

Also, various data is stored in a data store 221 that is accessible to the computing environment 203. The data store 221 can be representative of a plurality of data stores 221, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 221 is associated with the operation of the various applications or functional entities described below. This data can include the user profile 224, the merchant profile 225, the provider cryptocurrency wallet(s) 227, the provider CBDC wallet(s) 230, and potentially other data.

The user profile 224 can represent a profile or account for a user. In some examples, the remote computing device (e.g., the computing environment 203) of a financial service provider can have a user profile 224 for each financial account holder. The user profile 224 can include contact information (e.g., name, address, phone number, etc.). Additionally, the user profile 224 can include payment tokens 233, funding sources 114, device identifiers 236, preferences, and other suitable user profile data.

The payment token 233 can represent a payment credential or an alias for a financial account of the user. The payment token 233 can be stored in a client device 109, a payment instrument (e.g., a payment card), and other suitable payment mechanisms. In some non-limiting examples, the client device 109 can be a smart phone device, a tablet device, a wearable device (e.g., a smart watch, smart glasses, an activity tracking device, etc.), and other suitable client devices.

The funding sources 114 can represent one or more financial accounts that are managed or owned by the user. The funding sources 114 can include CBDC wallets, cryptocurrency accounts, credit card accounts, debit accounts, loyalty point accounts, and other suitable financial accounts. In some examples, one or more funding sources 114 can be configured to be automatically assigned to certain transactions. For example, a particular cryptocurrency account can be assigned as a funding source to a client device 109 when used at a POS device 106, as illustrated in FIG. 1. In some examples, the funding sources 114 can include data associated with one or more user wallets 242. The user wallets 242 can represent cryptocurrency wallets and/or CBDC wallets. For example, the user wallet 242 can include a private key associated with a cryptocurrency account of the user. The private key can be stored upon receiving authorization from the client device 109 of the user. The private key can be stored to enable the wallet service 217 to make withdrawals from CBDC wallets or other accounts on behalf of the user. In some examples, the withdrawal can be executed after getting authorization from the user for each transaction.

The device identifier 236 can represent a unique identifier for the client device 109 of the user. The device identifier 236 can be a phone number, a manufacturer serial number, an Internet Protocol (IP) address, and other suitable unique identifiers. In some embodiments, the device identifier 236 can be linked to one or more payment tokens 233. Thus, during a transaction with a merchant system such as a POS device 106, the computing environment 203 can transmit a request for confirmation or authorization of a funding source 114 for individual transactions.

The preferences 239 can represent configuration settings for facilitating the acceptance funding sources 114 for the client device 109. For example, the preferences 239 can indicate a selected assignment of a particular funding source 114 for a payment token 233. In some examples, the preferences 239 can include rules for determining the appropriate funding source 114 for a particular transaction. For instance, a contactless/contact transaction, such as one complying with a version of the Europay, Mastercard, and Visa (EMV) standard, can be assigned a first funding source 114. A second funding source 114 can be assigned settings for an online transaction. Thus, the transaction type can be used to determine the funding source 114. As another example, the funding source 114 can be determined based at least in part on one or more rules and transaction conditions, such as the transaction category (e.g., category for goods or services), the time and date of the transaction, the transaction location, and another suitable conditions.

The merchant profile 225 can represent a merchant account for a merchant. The merchant profile 225 can include information used to receive transaction data from one or more POS devices 106 of the merchant and to provide transaction proceeds to a financial account of the merchant (e.g., via a merchant CBDC wallet address). The merchant profile 225 can include a merchant CBDC wallet. The merchant CBDC wallet can include a wallet address or a public key for transferring digital currency to the merchant via the CBDC network 209.

The provider cryptocurrency wallet(s) 227 can represent a mechanism for storing and transferring cryptocurrency on a cryptocurrency blockchain for a financial service provider. The provider cryptocurrency wallet(s) 227 can store public and private keys and a wallet address (e.g., derived from the public key) for the provider cryptocurrency wallet 227. In some examples, the conversion service 218 can facilitate a cryptocurrency transaction from a client wallet of the user to the provider cryptocurrency wallet 227 of the financial service provider. The financial service provider can receive cryptocurrency on behalf of the merchant for a particular transaction. Then, the financial service provider can transfer the proceeds to a merchant wallet in a CBDC network 209. In some examples, the wallet address of the provider cryptocurrency wallet 227 can be provided to the client device 109 in order for the client device 109 to execute a blockchain transfer of the cryptocurrency transaction price to the wallet address of the provider cryptocurrency wallet 227. As such, the computing environment 203 (e.g., of a financial service provider) can receive the transaction payment of the item on behalf of the merchant in the form of cryptocurrency from the user.

The CBDC provider wallets 230 can represent a mechanism for storing and transferring digital currency on a central bank digital currency 209 for a financial service provider. The CBDC provider wallets 230 can store public and private keys. In some scenarios, a CBDC provider wallet 230 can exist for individual territories or countries. For example, a first CBDC provider wallet 230 can be used for a United States central bank digital currency and a second CBDC provider wallet 230 can be used for a European Union central bank digital currency. In some examples, after receiving cryptocurrency from a cryptocurrency account of a user for a transaction, the conversion service 218 can transfer proceeds to a merchant wallet at a CBDC network 209.

The client device 109 is representative of a plurality of client devices 109 that can be coupled to the network 215. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 109 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 109 or can be connected to the client device 109 through a wired or wireless connection.

The client device 109 can execute various applications such as a wallet application 247 or other applications. The wallet application 247 can interface with the conversion service 218 and/or wallet service 217. In some examples, the wallet application 247 can be associated with the computing environment for a financial services provider. The wallet application 247 can communicate with the wallet service 217 and/or the conversion service 218. The wallet application 247 can conduct transactions with a POS device 106 or any other merchant system to conduct transactions. The wallet application 247 can act as a “superwallet” that can store information about wallets 248 or user CBDC wallets 249 of a user. For example, the wallet application 247 can store references to various CBDC wallets, cryptocurrency wallets, credit cards, debit cards, or other payment instruments 103 of a user. The various wallets 248 or user CBDC wallets 249 can be utilized as funding sources 114 for transactions with merchant systems. The wallet application 247 can also store or act as a wholesale wallet that can store CBDC in amounts that exceed that which is permitted for user CBDC wallets 249. A wholesale wallet can be associated with different regulatory constraints than a user wallet. In some instances, a wholesale CBDC wallet Accordingly, a user can store references to multiple CBDC wallets that can used through the wallet application 247 to conduct transactions in an amount that might exceed maximum CBDC wallet regulatory limitations.

Additionally, the wallet application 247 can access network content served up by the computing environment 203 or other servers, thereby rendering a user interface 112 on the display. To this end, the wallet application 247 can include a browser, a dedicated application, or another executable applications, and the user interface 112 can include a network page, an application screen, or another user mechanism for obtaining user input. The client device 109 can be configured to execute applications beyond the wallet application 247 such as email applications, social networking applications, word processors, spreadsheets, or other applications.

The wallet application 247 can store payment tokens 233. Payment token 233 can be tokens that are generated by the wallet application 247 or third party systems that can be presented to a POS device 106 or another merchant system to represent a particular payment instrument 103. In one example, if a user selects a credit card stored in the wallet application 247 to be utilized as a payment instrument 103, the wallet application 247 can present a corresponding payment token 233 to the POS device 106, which can seek authorization for a transaction amount from a card issuer's approval system through a payment rail.

The merchant system 206 can represent a merchant network environment for conducting point of sale transactions in person at a physical store location or online. The merchant system 206 can include the POS device 106 for in-person and online transactions. The merchant system 206 can include a merchant CBDC wallet 251 for interacting with the CBDC network 209. The merchant CBDC wallet 251 can include a private key and a public key associated with the merchant system 206. The public key or a wallet address derived from the public key can be used for receiving digital currency for transaction proceeds at the CBDC network 209 (e.g., via a CBDC blockchain) from the transaction initiated by the conversion service 218. The transfer of these transaction proceeds can be part of a settlement process.

The CBDC network 209 can present an implementation of a central bank digital currency that is backed by one or more government entities. In some examples, the CBDC network 209 is implemented as a database that maintains the records of the transactions. For instance, the CBDC network 209 can be implemented as a blockchain network. In some scenarios, different territories or countries may have separate CBDCs. As such, the conversion service 218 can identify a merchant CBDC wallet 251 associated with the merchant system 206. In some cases, the transaction location can be used to identify an appropriate merchant CBDC wallet 251 in situations where the merchant system 206 has multiple merchant CBDC wallets 251. In other examples, the merchant profile 225 can include merchant preferences for identifying an appropriate CBDC for each transaction. The appropriate CBDC can be identified in the preferences based at least in part on one or more rules and one or more conditions. For example, a first rule of a particular merchant can indicate that the CBDC for Country A should be used for all transactions occurring in Country B. As another example, a second rule of a particular merchant can indicate the CBDC for Country C should be used for transactions that fall into a certain category and the transaction location is Country D.

A funding source system 211 can represent a system that can approve transactions on behalf of a merchant system 206 or a distributed ledger where transaction information is stored or recorded. A funding source system 211 can also represent an exchange whereby a first currency can be exchanged for a second currency on behalf of the wallet service 217, conversion service 218, merchant system 206, or the wallet application 247. A funding source system 211 can and represent a decentralized digital currency in which transactions are maintained on a blockchain network. The blockchain network can represent a distributed database that is not reliant any central authority, such as a bank or government. Some examples of cryptocurrencies can include Bitcoin, Litecoin, ETHEREUM, TETHER, USD Coin, BINANCE Coin, and other suitable cryptocurrencies.

Next, a general description of the operation of the various components of the network environment 200 is provided. To begin, a user can decide to purchase a particular item at a physical retail store. The user can present a client device 109 running the wallet application 247 to conduct a payment transaction for a transaction amount with a POS device 106. The POS device 106 can generate an authorization request based on the interaction with the wallet application 247. The authorization request can include a payment token 233 provided by the wallet application 247 that is associated with a funding source 114 selected by the user. The authorization request can be transmitted to a remote computing device (e.g., a computing environment 203) associated with a financial entity. The financial entity can be an issuing bank, an acquiring bank, a credit union, a payment processor, or other suitable financial entities. The merchant system 206 can obtain approval or verification of the transaction from a funding source system 211. The merchant system 206 can present the payment token 233 to a funding source system 211 along with transaction details, such as a transaction amount and other transaction metadata. The funding source system 211 can verify whether the payment token 233 is associated with an account that has sufficient funds for the transaction. The funding source system 211 can then debit the transaction amount from a user account and credit the amount to a merchant account. The funding source system 211 can then provide an approval of the transaction to the merchant system 206. In some examples, the funding source system 211 can also communicate with the user about the status of a debit or transaction via email or by communicating with the client device 109.

In some examples, instead of a payment token 233 presented by the wallet application 247, the wallet application 247 can transmit a token or indication representing an amount of a CBDC equaling the transaction amount. Alternatively, the token can represent a confirmation that the transaction amount of the CBDC has been transferred from one or more user CBDC wallet 249 to a merchant CBDC wallet. The confirmation can include an address on a CBDC ledger or blockchain that the merchant system 206 can verify. Upon verifying that the transaction amount of the CBDC has been transferred to a merchant CBDC wallet, the merchant system 206 can approve or finalize the transaction.

At the remote computing device, the payment token 233 can have associated preferences 239. The preferences 239 can include instructions for the remote computing device to request a selection of a funding source or request confirmation of a pre-selected funding source from the client device 109. Thus, the remote computing device can cause the client device 109 to activate a user interface prompting for receiving a selection of a funding source or for receiving confirmation of a pre-selected funding source. In a selection scenario, the user interface prompt 303 can include two or more funding sources 114. For example, the user interface prompt 303 can include a prompt that asks the user whether the transaction should be processed using a CBDC wallet as a funding source 114. Should the user approve the transaction via the user interface button 306, the wallet application 247 can cause a transaction amount to be transferred to the CBDC provider wallet 230 from a user CBDC wallet 249 or the wholesale wallet associated with the wallet application 247.

In one scenario, the wallet application 247 can utilize a wholesale wallet that is unique to the user or the client device 109 as a passthrough wallet from which funds from one or more funding sources 114 as passed through to the merchant's CBDC or other type of wallet. In this scenario, the wallet application 247 can transfer a transaction amount of the funds from the user CBDC wallet 249 to the wholesale wallet. The wallet application 247 can then transfer the transaction amount to a merchant CBDC wallet, such as a CBDC provider wallet 230.

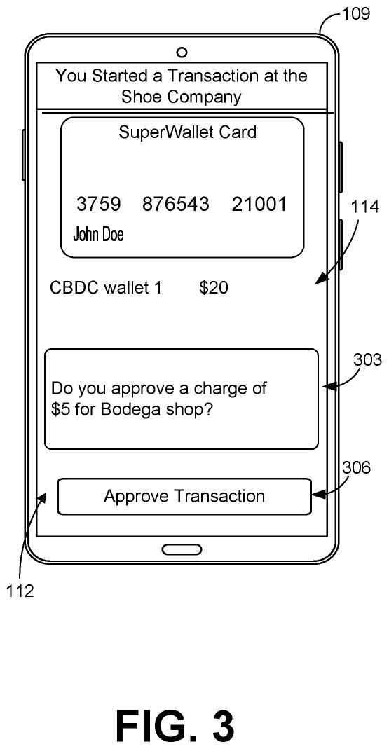

Referring next to FIG. 3, shown is a drawing of another example user interface 112 displayed by the client device 109. FIG. 3 illustrates an alternative user interface 112 from FIG. 1. In FIG. 3, the user interface 112 includes a depicted representation the wallet application 247, a listing of a particular funding source 114, a user interface prompt 303, a user interface button 306, and other suitable components. The wallet application 247 can be utilized by the user to make payments with the funding sources 114 that are loaded into the wallet application 247. In one example, the wallet application 247 can represent an application into which the user can load multiple user CBDC wallets 249. The user CBDC wallets 249 can be accompanied with regulatory restrictions on the amount of funds that can be loaded into the respective wallets, the amount of CBDC that can be spent from a single wallet at a given point in time, or other regulatory limitations that may not apply to the wholesale wallet assigned to the wallet application 247.

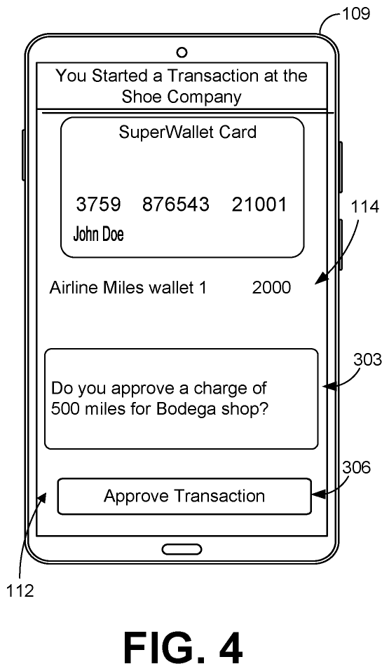

Referring next to FIG. 4, shown is a drawing of another example user interface 112 displayed by the client device 109. FIG. 4 illustrates an alternative user interface 112 from FIGS. 1 and 3. In FIG. 4, the user interface 112 includes a depicted representation the wallet application 247, a listing of a particular funding source 114, a user interface prompt 303, a user interface button 306, and other suitable components. The wallet application 247 can be utilized by the user to make payments with the funding sources 114 that are loaded into the wallet application 247. In one example, the wallet application 247 can represent an application into which the user can other types of wallets 248, such as cryptocurrency wallets, alternative currency wallets, an airline miles or rewards points account, or other types of funding sources or accounts that can be converted into a CBDC. The wallets 248 can have currency or points that require conversion to a CBDC so that a payment can be completed in association with a transaction. Accordingly, the wallet application 247 can request that the wallet service 217 and/or the conversion service 218 provide an indication of an amount of cryptocurrency, rewards points, airline miles, or alternative currency that are required to convert to a transaction amount of the CBDC associated with the transaction.

Accordingly, upon selection by a user of one or more funding sources 114, in the user interface 112, the wallet application 247 can display the amount in user interface prompt 303. The wallet application 247 can then seek approval of the transaction via the user interface button 306. Upon selection of the user interface button 306, the wallet application 247 can initiate conversion of the amount from the wallets 248 to the CBDC, which can be provided to the merchant CBDC wallet 251 associated with the transaction.

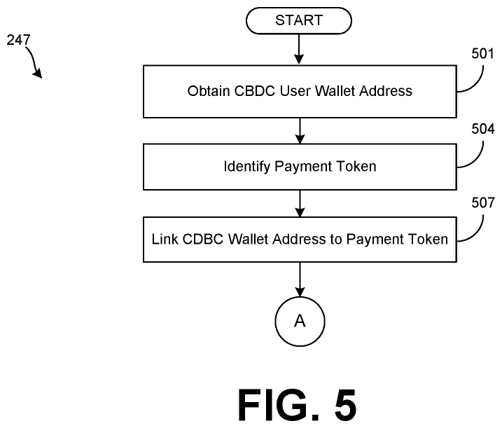

Referring next to FIG. 5, shown is a flowchart that provides one example of the operation of a portion of the wallet application 247. The flowchart of FIG. 5 provides merely an example of the many different types of functional arrangements that can be employed to implement the operation of the depicted portion of the wallet application 247. As an alternative, the flowchart of FIG. 5 can be viewed as depicting an example of elements of a method implemented within the client device 109. FIG. 5 illustrates how the wallet application can add a user CBDC wallet 249 to the wallet application 247 so that the use can transact using the user CBDC wallet 249 via the wallet application 247.

Beginning with step 501, the wallet application 247 can obtain a CBDC wallet address corresponding to a user CBDC wallet. The user CBDC wallet 249 can be associated with the public key or a wallet address that identifies the user's CBDC account or wallet on a CBDC network 209 blockchain or ledger. The private key can be retained by the user in some implementations. The wallet application 247 can display one or more user interfaces 112 on a client device 109 that allow the user to enter details about the user CBDC wallet, such as the public key or wallet address. The wallet application 247 can display one or more user interface 112 through which the user can enter a private key or wallet password corresponding to the user CBDC wallet 249.

At step 504, the wallet application 247 can obtain or generate a payment token 233 corresponding to the user CBDC wallet. The payment token 233 can be utilized by the wallet application 247 to facilitate transactions with a POS device 106 or any other merchant system 206. In some cases, the wallet application 247 can obtain or generate multiple payment tokens 233 that are for a single use or a limited number of uses. A payment token 233 can be presented by the wallet application 247 to a merchant system 206 or POS device 106 to initiate a payment on behalf of the user CBDC wallet 249. The merchant system 206 or POS device 106 can finalize a transaction by obtaining authorization from the wallet application 247 to complete the transaction or obtaining the authorization from a funding source system 211 that authorizes transactions on behalf of the user CBDC wallet.

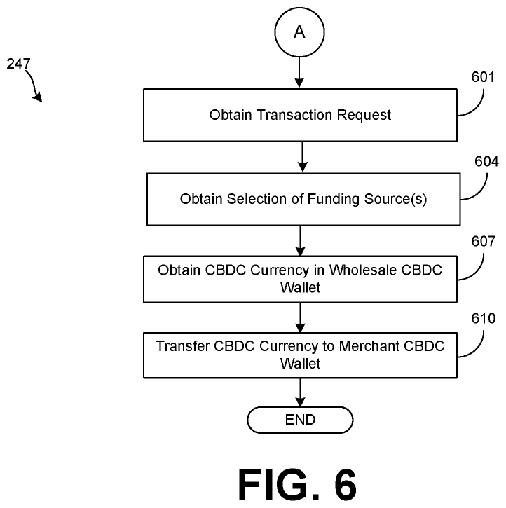

In step 507, the wallet application 247 can link the user CBDC wallet 249 to the payment token 233. The linkage can include storing preferences 239 (e.g., rules, transaction types, etc.) associated with the user CBDC wallet 249 that the user can select via one or more user interfaces 112 provided by the wallet application 247. For example, a first preference 239 can include limiting a transaction amount associated with a user CBDC wallet 249 added to the wallet application 247. In another example, a second preference 239 can include limiting a transaction type that can be utilized to complete transactions using the wallet application 247 and the linked user CBDC wallet. Thereafter, the process can continue as shown in FIG. 6.

Referring next to FIG. 6, shown is a flowchart that continues the process shown in FIG. 5 and continues the example of the operation of a portion of the wallet application 247. FIG. 6 illustrates how the wallet application 247 can facilitate a transaction with a merchant or another user while utilizing one or more funding source 114 loaded into the wallet application 247.

In step 601, the wallet application 247 can obtain a transaction request. The request can be obtained from another device, such as a POS device 106. The request can also be initiated by a user via a user interface 112 provided by the wallet application 247. The request can include a transaction amount in a currency specified by the request. The currency can be specified by a merchant or a user initiating the transaction.

At step 604, wallet application 247 can obtain a selection of one or more funding sources 114 with which to fund the transaction. In one example, the wallet application 247 can display a user interface 112 showing the transaction amount as well as one or more funding source 114 to which the wallet application 247 has access to utilize for the transaction. In some examples, the user interface 112 can display transaction data, such as the merchant information, products or services associated with the transaction, transaction location, merchant transaction price, and other suitable data. The user interface 112 can also include transaction amount or price converted into the various currencies, credits, points, or other units associated with the respective funding sources 114. In some instances, the user interface 112 can display an account balance for one or more of the funding sources 114. In the case of a user CBDC wallet 249, the account balance can show the amount of CBDC in the respective user CBDC wallet 249.

The wallet application 247 can receive a selection or confirmation of the funding source 114 from the user interface 112. In some embodiments, the wallet application 247 can transmit to the wallet service 217 the confirmation or the selection of the funding source 114.

At step 607, the wallet application 247 can obtain the transaction amount of the selected currency, such as the CBDC, from the one or more selected funding source 114. In some instances, more than one funding source 114 can be selected if a single funding source 114 does not have enough funds or credit to provide the requested transaction amount. For example, a single user CBDC wallet 249 may not be allowed to hold a sufficient quantity of CBDC to complete the transaction. Accordingly, the wallet application 247 can prompt the user to select multiple funding sources 114 stored in the wallet application 247 until the transaction amount is met. In one scenario, the wallet application 247 can prompt the user to select multiple user CBDC wallets stored in the wallet application 247. In another scenario, the user can select a user CBDC wallet 249 along with another type of a wallet, such as an airline miles account, a credit card, a cryptocurrency wallet, etc.

In the case of multiple user CBDC wallets, the wallet application 247 can transfer the transaction amount of the CBDC from the wallets into a wholesale wallet created by the wallet application 247. In some situations, the wallet application 247 can cause a conversion of another currency, cryptocurrency, airline miles, rewards points, or other type of currency or points by the conversion service 218, into the transaction amount of the CBDC. The converted CBDC can be transferred into the wholesale wallet corresponding to the wallet application 247.

In step 610, the wallet application 247 can cause the transfer of the transaction amount of the currency to the merchant or other recipient of the currency. In one example, the wallet application 247 can cause a blockchain transfer on the CBDC network 209. In some embodiments, the wallet application 247 executes the blockchain transfer with a cryptocurrency blockchain 212. In these embodiments, the wallet application 247 can be provided the wallet address of the provider cryptocurrency wallet 227 or the public key associated with the provider cryptocurrency wallet 227.

In other embodiments, the conversion service 218 can execute the blockchain transfer on behalf of the wallet application 247. In these embodiments, the wallet service 217 can have access to the private key for the wallet corresponding to the selected funding source 114. For instance, the wallet application 247 or the user through a user interface 112 can provide the private key and authorization to use the private key. The blockchain transfer can comprise a digital signature and a merchant cryptographic key, where the signature corresponds to a private key corresponding to the user wallet and the merchant cryptographic key can identify a receiving wallet. Thereafter, the process can proceed to completion.

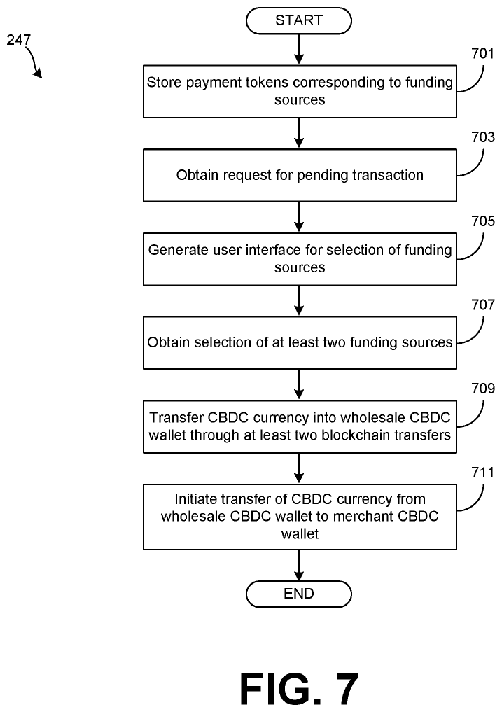

Referring next to FIG. 7, shown is a flowchart that provides one example of the operation of a portion of the wallet application 247. The flowchart of FIG. 7 provides merely an example of the many different types of functional arrangements that can be employed to implement the operation of the depicted portion of the wallet application 247. As an alternative, the flowchart of FIG. 7 can be viewed as depicting an example of elements of a method implemented within the client device 109. FIG. 7 illustrates how the wallet application 247 can perform multiple transfers to allow a user to utilize multiple user CBDC wallets to complete transactions with a merchant.

First, at step 701, the wallet application 247 can store payment tokens 233 corresponding to funding sources 114. The payment tokens 233 can correspond to funding sources 114 that are added to the wallet application 247 by a user. The payment tokens 233 can be presented to a merchant system 206, such as a POS device 106, to complete payment transactions with a merchant. When a user adds funding sources 114 to the wallet application 247, the wallet application 247 can generate or obtain payment tokens 233 corresponding to the funding sources 114, which are stored on the client device 109.

At step 703, the wallet application 247 can obtain a transaction request. The request can be obtained from another device, such as a POS device 106. The request can also be initiated by a user via a user interface 112 provided by the wallet application 247. The request can include a transaction amount in a currency specified by the request. The currency can be specified by a merchant or a user initiating the transaction.

At step 705, the wallet application 247 can generate a user interface 112 through which a user can select funding sources 114 that can be utilized to fund a transaction. In the scenario of FIG. 7, the transaction amount for the transaction is more than an amount held in any one wallet 248 in the wallet application 247 or more than amount that is allowed to be stored in a user CBDC wallet 249. As noted above, a user CBDC wallet 249 can be accompanied with a regulatory restriction that limits the amount of CBDC that is allowed to be held in the user CBDC wallet 249. Such a restriction might not apply to a wholesale CBDC wallet that is associated with the wallet application 247 or an issuer of the wallet application 247.

At step 707, wallet application 247 can obtain a selection of one or more funding sources 114 with which to fund the transaction. In one example, the wallet application 247 can display a user interface 112 showing the transaction amount as well as one or more funding source 114 to which the wallet application 247 has access to utilize for the transaction. In some examples, the user interface 112 can display transaction data, such as the merchant information, products or services associated with the transaction, transaction location, merchant transaction price, and other suitable data. The user interface 112 can also include transaction amount or price converted into the various currencies, credits, points, or other units associated with the respective funding sources 114. In some instances, the user interface 112 can display an account balance for one or more of the funding sources 114. In the case of a user CBDC wallet 249, the account balance can show the amount of CBDC in the respective user CBDC wallet 249.

At step 709, the wallet application 247 can transfer the transaction amount of the CBDC from the user CBDC wallets 249 into a wholesale CBDC wallet created by or on behalf of the wallet application 247. In one scenario, the wallet application 247 can initiate at least two or multiple blockchain transfers via the CBDC network 209 to transfer two amounts of CBDC that together equal the transaction amount of the CBDC from user CBDC wallets 249 stored in the wallet application 247 to the wholesale wallet.

At step 711, the wallet application 247 can initiate the transfer of the transaction amount of the CBDC from the wholesale wallet to the merchant or other recipient of the currency. In one example, the wallet application 247 can cause a blockchain transfer on the CBDC network 209.

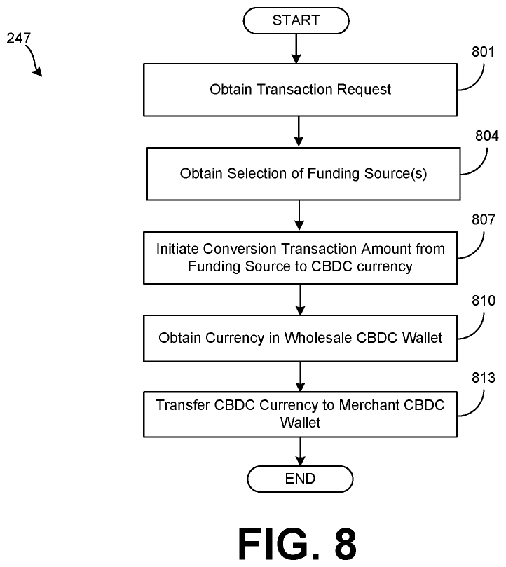

Referring next to FIG. 8, shown is a flowchart that provides one example of the operation of a portion of the wallet application 247. The flowchart of FIG. 8 provides merely an example of the many different types of functional arrangements that can be employed to implement the operation of the depicted portion of the wallet application 247. As an alternative, the flowchart of FIG. 8 can be viewed as depicting an example of elements of a method implemented within the client device 109. FIG. 8 illustrates how the wallet application 247 can convert currency, miles, or points other than a CBDC to complete a transaction using the CBDC.

First, at step 801 the wallet application 247 can obtain a transaction request. The request can be obtained from another device, such as a POS device 106. The request can also be initiated by a user via a user interface 112 provided by the wallet application 247. The request can include a transaction amount in a currency specified by the request. The currency can be specified by a merchant or a user initiating the transaction.

At step 804, wallet application 247 can obtain a selection of one or more funding sources 114 with which to fund the transaction. In one example, the wallet application 247 can display a user interface 112 showing the transaction amount as well as one or more funding source 114 to which the wallet application 247 has access to utilize for the transaction. In some examples, the user interface 112 can display transaction data, such as the merchant information, products or services associated with the transaction, transaction location, merchant transaction price, and other suitable data. The user interface 112 can also include a transaction amount or price converted into the various currencies, credits, points, or other units associated with the respective funding sources 114. In some instances, the user interface 112 can display an account balance for one or more of the funding sources 114. In the case of a wallet 248 associated with a currency other than a CBDC, the account balance can show the amount of currency, miles, or points in the respective wallet 248.

At step 807, the wallet application 247 can initiate conversion of the transaction amount of the selected funding source 114 currency into the transaction amount of the CBDC. To initiate conversion, the wallet application 247 can request that the conversion service 218 perform conversion of the currency, miles or points into the CBDC.

At step 810, the wallet application 247 can obtain the transaction amount of the CBDC from the conversion service 218. The converted CBDC can be transferred into the wholesale wallet corresponding to the wallet application 247.

In step 813, the wallet application 247 can cause the transfer of the transaction amount of the CBDC to the merchant or other recipient of the currency. In one example, the wallet application 247 can cause a blockchain transfer on the CBDC network 209. Thereafter, the process can proceed to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 5-8 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts of FIGS. 5-8 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 5-8 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a client device comprising a processor and a memory; and
machine-readable instructions stored in the memory that, when executed by the processor, cause the client device to at least:
receive a transaction request comprising a transaction amount, a merchant account identifier, a central bank digital currency (CBDC) type associated with the merchant account identifier, and one or more funding sources, wherein the one or more funding sources comprise at least one of a cryptocurrency, a rewards points balance, an airline miles balance, or one or more currencies;
transmit a conversion request for the transaction amount to the CBDC to initiate a conversion of the transaction amount to the CBDC, the conversion request comprising the one or more funding sources, the CBDC type, and the transaction amount in order to initiate a conversion of the transaction amount to the CBDC;
obtain a converted transaction amount from the conversion service in a wholesale CBDC wallet; and
initiate a blockchain transfer on a CBDC network of the converted transaction amount from the wholesale CBDC wallet to a merchant account associated with the merchant account identifier.

2. The system of claim 1, wherein the transaction request is received from at least one of a point-of-sale device or a user interface of the client device.

3. The system of claim 1, wherein the machine-readable instructions, when executed by the processor, further cause the client device to obtain a selection of the one or more funding source.

4. The system of claim 1, wherein the one or more funding source is a first funding source, and the transaction request further comprises a second funding source, and wherein the conversion request further comprises the second funding source.

5. The system of claim 4, wherein the conversion request specifies portions of the transaction amount corresponding to the first funding source and the second funding source.

6. The system of claim 1, wherein obtaining the converted transaction amount from the conversion service further comprises receiving the converted transaction amount of the CBDC type associated with the merchant account identifier and transferring the converted transaction amount into the wholesale CBDC wallet.

7. The system of claim 1, wherein the blockchain transfer comprises transferring the converted transaction amount on the CBDC network to a merchant CBDC wallet associated with the merchant account.

8. A method, comprising:
receiving a transaction request comprising a transaction amount, a merchant account identifier, a central bank digital currency (CBDC) type associated with the merchant account identifier, and one or more funding sources, wherein the one or more funding sources comprise at least one of a cryptocurrency, a rewards points balance, an airline miles balance, or one or more currencies;
transmitting a conversion request for the transaction amount to the CBDC to initiate a conversion of the transaction amount to the CBDC, the conversion request comprising the one or more funding sources, the CBDC type, and the transaction amount in order to initiate a conversion of the transaction amount to the CBDC;
obtaining a converted transaction amount from the conversion service in a wholesale CBDC wallet; and
initiating a blockchain transfer on a CBDC network of the converted transaction amount from the wholesale CBDC wallet to a merchant account associated with the merchant account identifier.

9. The method of claim 8, wherein the transaction request is received from at least one of a point-of-sale device or a user interface of a client device.

10. The method of claim 8, further comprising obtaining a selection of the one or more funding source.

11. The method of claim 8, wherein the one or more funding source is a first funding source, and the transaction request further comprises a second funding source, and wherein the conversion request further comprises the second funding source.

12. The method of claim 11, wherein the conversion request specifies portions of the transaction amount corresponding to the first funding source and the second funding source.

13. The method of claim 8, wherein obtaining the converted transaction amount from the conversion service further comprises receiving the converted transaction amount of the CBDC type associated with the merchant account identifier and transferring the converted transaction amount into the wholesale CBDC wallet.

14. The method of claim 8, wherein the blockchain transfer comprises transferring the converted transaction amount on the CBDC network to a merchant CBDC wallet associated with the merchant account.

15. A non-transitory, computer-readable medium, comprising machine-readable instructions that, when executed by a processor of a computing device, cause the computing device to at least:
receive a transaction request comprising a transaction amount, a merchant account identifier, a central bank digital currency (CBDC) type associated with the merchant account identifier, and one or more funding sources, wherein the one or more funding sources comprise at least one of a cryptocurrency, a rewards points balance, an airline miles balance, or one or more currencies;
transmit a conversion request for the transaction amount to the CBDC to initiate a conversion of the transaction amount to the CBDC, the conversion request comprising the one or more funding sources, the CBDC type, and the transaction amount in order to initiate a conversion of the transaction amount to the CBDC;
obtain a converted transaction amount from the conversion service in a wholesale CBDC wallet; and
initiate a blockchain transfer on a CBDC network of the converted transaction amount from the wholesale CBDC wallet to a merchant account associated with the merchant account identifier.

16. The non-transitory, computer-readable medium of claim 15, wherein the transaction request is received from at least one of a point-of-sale device or a user interface of a client device.

17. The non-transitory, computer-readable medium of claim 15, wherein the machine-readable instructions, when executed by the processor, further cause the computing device to obtain a selection of the one or more funding source.

18. The non-transitory, computer-readable medium of claim 15, wherein the one or more funding source is a first funding source, and the transaction request further comprises a second funding source, and wherein the conversion request further comprises the second funding source.

19. The non-transitory, computer-readable medium of claim 18, wherein the conversion request specifies portions of the transaction amount corresponding to the first funding source and the second funding source.

20. The non-transitory, computer-readable medium of claim 15, wherein obtaining the converted transaction amount from the conversion service further comprises receiving the converted transaction amount of the CBDC type associated with the merchant account identifier and transferring the converted transaction amount into the wholesale CBDC wallet.
